(19) United States
(12) Patent Application Publication
(10) Pub. No.: US 2009/0021484 A1
(43) Pub. Date: Jan. 22, 2009

(54) OPTICAL POINTING DEVICE AND AUTOMATIC GAIN CONTROL METHOD THEREOF

(75) Inventors: JONG-TAEK KWAK, Seongnam-si (KR); YOUNG-HO SHIN, Yongin-si (KR)

Correspondence Address: CANTOR COLBURN, LLP, 20 Church Street, 22nd Floor, Hartford, CT, 06103, US

(73) Assignee: ATLAB INC., Yongin-si (KR)

(21) Appl. No.: 12/170,143

(22) Filed: Jul. 9, 2008

(30) Foreign Application Priority Data
Jul. 18, 2007 (KR) 10-2007-0071892

(51) Int. Cl. G09G 5/08

(52) U.S. Cl. 345/166

(57) ABSTRACT

Provided are an optical pointing apparatus and an automatic gain control (AGC) method thereof. The optical pointing apparatus includes: an image sensor comprised of a plurality of pixels, for receiving light reflected by a work surface, sensing image data, and outputting an electrical signal; an automatic gain control (AGC) unit for receiving the electrical signal, controlling the gain of the electrical signal according to brightness and darkness from images of the work surface and the motion speed of the optical pointing apparatus, and outputting a gain output signal; and an image data processor for receiving the gain output signal, analyzing brightness and darkness from images of the work surface to control the gain of the electrical signal, detecting the motion speed of the optical pointing apparatus to control the gain of the electrical signal, and calculating and outputting the motion speed of the optical pointing apparatus.

This application claims the benefit of Korean Patent Application No. 2007-0071892, filed Jul. 18, 2007, the contents of which are hereby incorporated herein by reference in their entirety.

### BACKGROUND OF THE INVENTION

1. Field of the Invention

The present invention relates to an optical pointing apparatus and, more particularly, to an optical pointing apparatus which restricts the intensity of an image signal and controls the gain of a voltage of the image signal according to the intensity of incident light, in order to obtain a precise image in response to an input signal having at least a predetermined light intensity, and an automatic gain control (AGC) method thereof.

2. Description of Related Art

A mouse, which is a kind of an optical pointing apparatus, is a basic peripheral device of a computer. In recent years, optical mice using optical sensor chips, which calculate the direction and speed from image data of a work surface at high speed to find the coordinates of the optical mice, are being used more widely than ball mice.

Motion information of an optical mouse is based on a correlation between present and previous image data on a work surface on which the optical mouse is placed, and the image data are sequentially collected by an image sensor.

In order to obtain the image data on the work surface on which the optical mouse is placed, an image is received in the form of light, an analog signal is generated, received, and converted into a digital signal, the motion information is calculated, and the digital signal is output.

FIG. 1 is a block diagram of a conventional optical pointing apparatus.

Referring to FIG. 1, the conventional optical pointing apparatus includes an optical unit 10, an image sensor 20, an analog-to-digital converter (ADC) 30, and a motion value calculator 40. The image sensor 20 is comprised of a plurality of pixels, and the optical unit 10 is comprised of a light source and a lens.

Operation of the conventional optical pointing apparatus will now be described with reference to FIG. 1.

The optical unit 10 radiates light onto a work surface using the light source and transmits light reflected by the work surface through the lens to the image sensor 20. The image sensor 20 receives the reflected light through the lens and senses light data. The ADC 30 receives an analog signal output from the image sensor 20 and converts the analog signal into a digital signal. The motion value calculator 40 calculates a correlation value between current image data and previous image data based on the digital signal output from the ADC 30, calculates a coordinate motion value V(MOV) of the optical pointing apparatus based on the correlation value, and outputs the motion value V(MOV).

In general, the ADC 30 of the optical pointing apparatus has a fixed input range. In this case, a relatively precise image can be obtained in response to an input signal whose light intensity is within a predetermined range, while it is difficult to obtain a precise image in response to an input signal whose light intensity is outside the predetermined range.

In order to make up for these weak points, an automatic gain control (AGC) unit for restricting signal intensity according to the intensity of incident light has been adopted. The AGC unit estimates digital data received from the ADC 30, controls the speed and gain of a shutter included in an optical pointing sensing unit, and prevents saturation and underexposure of an image captured by the image sensor 20.

However, a wireless optical pointing apparatus performs shutter-on control and light-on control in order to reduce power consumption. When the wireless optical pointing apparatus is placed on a white or light-color work surface, a shutter-on time and a light-on time are short; on the other hand, when the wireless optical pointing apparatus is placed on a black or dark-color work surface, a shutter-on time must be maximized, so that a light-on time is also extended and power consumption of a light source increases.

In this case, when the shutter-on time of the optical pointing apparatus placed on the dark-color work surface is too short, a method of increasing the gain of the ADC 30 may be employed in order to ensure required light intensity. However, since a frame rate must be increased to maximize the motion speed of the optical pointing apparatus, there is a specific technical limit to increasing the shutter-on time.

In particular, when the optical pointing apparatus is placed on the dark work surface, it is unavoidable that the shutter-on time is markedly reduced due to a rise in the frame rate. Accordingly, when the optical pointing apparatus moves at low speed, a frame rate may be reduced to ensure a sufficient shutter-on time, and when the optical pointing apparatus moves at a high speed, it is likely that the motion of the optical pointing apparatus cannot be detected when motion is beyond a pixel search window multiplied with the frame rate. Therefore, it is necessary to appropriately control the motion speed and shutter-on time of the optical pointing apparatus.

### SUMMARY OF THE INVENTION

An embodiment of the invention provides an optical pointing apparatus which fluidly controls the illumination of a light source, a shutter-on time, and gain of an image signal according to the brightness of a work surface and the motion speed of the optical pointing apparatus.

Another embodiment of the invention provides an automatic gain control (AGC) method of the above-described optical pointing apparatus.

In one aspect, the present invention is directed to an optical pointing apparatus including: an image sensor comprised of a plurality of pixels, for receiving light reflected by a work surface, sensing image data, and outputting an electrical signal; an AGC unit for receiving the electrical signal, controlling the gain of the electrical signal according to brightness and darkness from images of the work surface and the motion speed of the optical pointing apparatus, and outputting a gain output signal; and an image data processor for receiving the gain output signal, analyzing brightness and darkness from images of the work surface to control the gain of the electrical signal, detecting the motion speed of the optical pointing apparatus to control the gain of the electrical signal, and calculating and outputting the motion speed of the optical pointing apparatus.

The optical pointing apparatus may further include: an optical unit for radiating light onto the work surface using a light source and transmitting the light reflected by the work surface through a lens; a multiplexer for receiving the electrical signal, selecting at least one pixel out of the plurality of pixels, and outputting an electrical signal of the selected pixel; and an analog-to-digital converter (ADC) for receiving the gain output signal and converting the gain output signal into a digital image signal.

The AGC unit may receive the electrical signal of the selected pixel, compare the gain of the electrical signal with a maximum gain and a minimum gain, maintain the gain of the electrical signal when the gain of the electrical signal is smaller than the maximum gain or larger than the minimum gain, reduce the gain of the electrical signal by a predetermined level when the gain of the electrical signal is larger than the maximum gain, and increase the gain of the electrical signal by a predetermined level when the gain of the electrical signal is smaller than the minimum gain.

The AGC unit may include a single variable gain amplifier, which outputs the gain output signal in a linear gain range in an analog mode according to voltage levels of gain control signals.

The AGC unit may include a plurality of variable gain amplifiers, which selectively output the gain output signal in a discontinuous gain range according to voltage levels of gain control signals.

The AGC unit may include: a first variable gain amplifier for receiving the electrical signal of the selected pixel, controlling the gain of the electrical signal by a predetermined level, and outputting a first gain output signal; second through N-th variable gain amplifiers connected to the first variable gain amplifier in series for receiving a gain output signal from a front-stage variable gain amplifier, controlling the gain of the received gain output signal by a predetermined level, and outputting a corresponding one of second through N-th gain output signals; and a variable gain multiplexer for receiving the first through N-th gain output signals and selectively outputting one of the first through N-th gain output signals according to brightness and darkness from images of the work surface or the motion speed of the optical pointing apparatus, in response to the voltage levels of the gain control signals.

The image data processor may include: an image analyzer for receiving the digital image signal, analyzing brightness and darkness from images of the work surface, outputting a light source control signal for controlling the illumination of the light source to the optical unit, outputting a shutter control signal for controlling a shutter-on time to the image sensor, and outputting a first gain control signal for controlling the gain of the electrical signal of the selected pixel to the AGC unit; a motion detector for receiving the digital image signal, detecting the motion speed of the optical pointing apparatus, and outputting a second gain control signal to the AGC unit; and a motion value calculator for receiving the digital image signal, calculating a correlation value between current image data and previous image data, calculating a coordinate motion value of the optical pointing apparatus based on the correlation value, and outputting the coordinate motion value.

The image analyzer may output a shutter control signal for reducing the shutter-on time, a light source control signal for reducing a light-on time, and a gain control signal for reducing the gain of the electrical signal of the selected pixel when the work surface is bright, and output a shutter control signal for increasing the shutter-on time, a light source control signal for increasing the light-on time, and a gain control signal for increasing the gain of the electrical signal of the selected pixel when the work surface is dark.

The image analyzer may receive the digital image signal, calculate the average of the digital image signal, compare the average with minimum and maximum values, and output the shutter control signal prior to the gain control signal. In this case, the image analyzer may output a shutter control signal for reducing the shutter-on time by a predetermined time when the average is larger than the maximum value, and output a shutter control signal for increasing the shutter-on time by a predetermined time when the average is smaller than the minimum value.

The image analyzer may receive the digital image signal, calculate the average of the digital image signal, compare the average with minimum and maximum values, and output the gain control signal prior to the shutter control signal. In this case, the image analyzer may output a gain control signal for reducing the gain of the electrical signal of the selected pixel by a predetermined level when the average is larger than the maximum value, and output a gain control signal for increasing the gain of the electrical signal of the selected pixel by a predetermined level when the average is smaller than the minimum value.

The image analyzer may receive the digital image signal, calculate the average of the digital image signal, compare the average with minimum and maximum values, and output the light source control signal prior to the shutter control signal and the gain control signal. In this case, the image analyzer may output a light source control signal for reducing the light-on time by a predetermined time when the average is larger than the maximum value, and output a light source control signal for increasing the light-on time by a predetermined time when the average is smaller than the minimum value.

The motion detector may output a gain control signal for reducing the gain of the electrical signal of the selected pixel when the motion speed of the optical pointing apparatus is lower than a minimum speed, and output a gain control signal for increasing the gain of the electrical signal of the selected pixel when the motion speed of the optical pointing apparatus is higher than a maximum speed.

In another aspect, the present invention is directed to an AGC method of an optical pointing apparatus including: an image sensor for receiving light reflected by a work surface, sensing image data, and outputting an electrical signal; and an ADC for converting the electrical signal into a digital image signal. The method includes: an AGC step including receiving the electrical signal, controlling the gain of the electrical signal according to brightness and darkness from images of the work surface and the motion speed of the optical pointing apparatus, and outputting a gain output signal; and an image data processing step including receiving the gain output signal, analyzing brightness and darkness from images of the work surface to control the gain of the electrical signal, detecting the motion speed of the optical pointing apparatus to control the gain of the electrical signal, and calculating and outputting a motion value of the optical pointing apparatus.

The AGC step may include comparing the gain of the electrical signal with maximum and minimum gains, maintaining the gain of the electrical signal when the gain of the electrical signal is larger than a maximum gain or smaller than a minimum gain, reducing the gain of the electrical signal by a predetermined level when the gain of the electrical signal is larger than the maximum gain, and increasing the gain of the electrical signal by a predetermined level when the gain of the electrical signal is smaller than the minimum gain.

The image data processing step may include: an image analysis step including receiving the digital image signal, analyzing brightness and darkness from images of the work surface, and outputting a light source control signal for controlling the illumination of a light source, a shutter control signal for controlling a shutter-on time, and a first gain control signal for controlling the gain of the electrical signal; a motion detection step including receiving the digital image signal, detecting the motion speed of the optical pointing apparatus, and outputting a second gain control signal; and a motion value calculation step including receiving the digital image signal, calculating a correlation value between current image data and previous image data, calculating a coordinate motion value of the optical pointing apparatus based on the correlation value, and outputting the coordinate motion value.

The image analysis step may include: outputting a shutter control signal for reducing the shutter-on time, a light source control signal for reducing a light-on time, and a gain control signal for reducing the gain of the electrical signal when the work surface is bright; and outputting a shutter control signal for increasing the shutter-on time, a light source control signal for increasing a light-on time, and a gain control signal for increasing the gain of the electrical signal when the work surface is dark.

The image analysis step may include: a work surface brightness analysis step including receiving the digital image signal, calculating the average of the digital image signal, and comparing the average with minimum and maximum values; a shutter-on time control step including reducing the shutter-on time by a predetermined time when the average is larger than the maximum value and increasing the shutter-on time by a predetermined time when the average is smaller than the minimum value; a first gain control step including comparing the gain of the electrical signal with the maximum gain to control the gain of the electrical signal when the shutter-on time is reduced by the predetermined time; and a second gain control step including comparing the gain of the electrical signal with the minimum gain to control the gain of the electrical signal when the shutter-on time is increased by the predetermined time.

The first gain control step may include: comparing the gain of the electrical signal with the maximum gain; maintaining the gain of the electrical signal when the gain of the electrical signal is smaller than the maximum gain; and reducing the gain of the electrical signal by a predetermined level when the gain of the electrical signal is larger than the maximum gain.

The second gain control step may include: comparing the gain of the electrical signal with the minimum gain; maintaining the gain of the electrical signal when the gain of the electrical signal is larger than the minimum gain; and increasing the gain of the electrical signal by a predetermined level than when the gain of the electrical signal is smaller than the minimum gain.

The image analysis step may further include returning to the work surface brightness analysis step after performing the first and second gain control steps.

The image analysis step may include: a work surface brightness analysis step including receiving the digital image signal, calculating the average of the digital image signal, and comparing the average with minimum and maximum values; a gain control step including reducing the gain of the electrical signal by a predetermined level when the average is larger than the maximum value and increasing the gain of the electrical signal by a predetermined level when the average is smaller than the minimum value; a first shutter-on time control step including comparing the shutter-on time with a maximum shutter-on time to control the shutter-on time when the gain of the electrical signal is reduced by the predetermined level; and a second shutter-on time control step including comparing the shutter-on time with a minimum shutter-on time to control the shutter-on time when the gain of the electrical signal is increased by the predetermined level.

The image analysis step may further include returning to the work surface brightness analysis step after performing the first and second shutter-on time control steps.

The image analysis step may include: a work surface brightness analysis step including receiving the digital image signal, calculating the average of the digital image signal, and comparing the average with minimum and maximum values; a light-on time control step including reducing the light-on time by a predetermined time when the average is larger than the maximum value and increasing the light-on time by a predetermined time when the average is smaller than the minimum value; a first shutter-on time control step including comparing the shutter-on time with a maximum shutter-on time to control the shutter-on time when the light-on time is reduced by the predetermined time; and a second shutter-on time control step including comparing the shutter-on time with a minimum shutter-on time to control the shutter-on time when the light-on time is increased by the predetermined time.

The first shutter-on time control step may include: comparing the shutter-on time with the maximum shutter-on time; maintaining the shutter-on time when the shutter-on time is shorter than the maximum shutter-on time; and reducing the shutter-on time by the predetermined time when the shutter-on time is longer than the maximum shutter-on time.

The second shutter-on time control step may include: comparing the shutter-on time with the minimum shutter-on time; maintaining the shutter-on time when the shutter-on time is longer than the minimum shutter-on time; and increasing the shutter-on time by the predetermined time when the shutter-on time is shorter than the minimum shutter-on time.

The image analysis step may include: a first determination of shutter-on time step including determining if the shutter-on time reduced in the first shutter-on time control step is the minimum shutter-on time; a first gain control step including returning to the work surface brightness analysis step when the reduced shutter-on time is not the minimum shutter-on time, and comparing the gain of the electrical signal with the maximum gain to control the gain of the electrical signal when the reduced shutter-on time is the minimum shutter-on time; a second determination of shutter-on time step including determining if the shutter-on time increased in the second shutter-on time control step is the maximum shutter-on time; and a second gain control step including returning to the work surface brightness analysis step when the increased shutter-on time is not the maximum shutter-on time, and comparing the gain of the electrical signal with the minimum gain to control the gain of the electrical signal when the increased shutter-on time is the maximum shutter-on time.

The first gain control step may include: comparing the gain of the electrical signal with the maximum gain; maintaining the gain of the electrical signal when the gain of the electrical signal is smaller than the maximum gain; and reducing the gain of the electrical signal by a predetermined level when the gain of the electrical signal is larger than the maximum gain.

The second gain control step may include: comparing the gain of the electrical signal with the minimum gain; maintaining the gain of the electrical signal when the gain of the electrical signal is larger than the minimum gain; and increasing the gain of the electrical signal by a predetermined level when the gain of the electrical signal is smaller than the minimum gain.

The image analysis step may further include returning to the work surface brightness analysis step after performing the first and second gain control steps.

The motion detection step may include: a motion speed analysis step including receiving the digital image signal, calculating the average motion speed of the optical pointing apparatus, and comparing the average motion speed with maximum and minimum speeds; maintaining the gain of the electrical signal when the average motion speed is higher than the minimum speed and lower than the maximum speed; increasing the gain of the electrical signal by a predetermined level when the average motion speed is higher than the maximum speed; and reducing the gain of the electrical signal by a predetermined level when the average motion speed is lower than the minimum speed.

The motion detection step may further include returning to analyzing the motion speed of the optical pointing apparatus after controlling the gain of the electrical signal.

### BRIEF DESCRIPTION OF THE DRAWINGS

The foregoing and other objects, features and advantages of the invention will be apparent from the following more particular description of exemplary embodiments of the invention, as illustrated in the accompanying drawings. The drawings are not necessarily to scale, emphasis instead being placed upon illustrating the principles of the invention.

FIG. 1 is a block diagram of a conventional optical pointing apparatus.

FIG. 2 is a block diagram of an optical pointing apparatus according to an exemplary embodiment of the present invention.

FIG. 3 is an internal block diagram of an automatic gain control (AGC) unit of the optical pointing apparatus shown in FIG. 2.

FIG. 4A is a circuit diagram of a first example of a first AGC unit of an AGC unit shown in FIG. 3.

FIG. 4B is a circuit diagram of a second example of the first AGC unit of the AGC unit shown in FIG. 3.

FIG. 5 is an operation flowchart of an optical pointing apparatus according to a first exemplary embodiment of the present invention, in a case where a shutter-on time is controlled prior to gain of an image signal according to the brightness of a work surface.

FIG. 6 is an operation flowchart of an optical pointing apparatus according to a second exemplary embodiment of the present invention, in a case where gain of an image signal is controlled prior to a shutter-on time according to the brightness of a work surface.

FIG. 7 is an operation flowchart of an optical pointing apparatus according to a third exemplary embodiment of the present invention, in a case where a light-on time is controlled prior to gain of an image signal and a shutter-on time according to the brightness of a work surface.

FIG. 8 is an operation flowchart of an optical pointing apparatus according to a fourth another exemplary embodiment of the present invention, in a case where gain of an image signal is controlled according to motion speed.

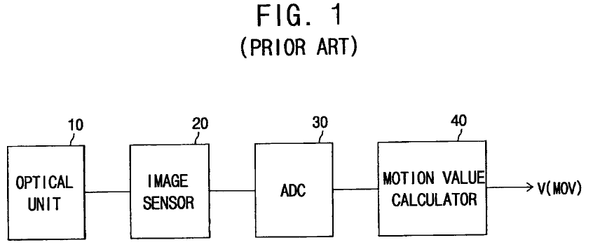

### DETAILED DESCRIPTION OF THE INVENTION

An optical pointing apparatus and an automatic gain control (AGC) method thereof according to the present invention will be described more fully hereinafter with reference to the accompanying drawings, in which exemplary embodiments of the invention are shown.

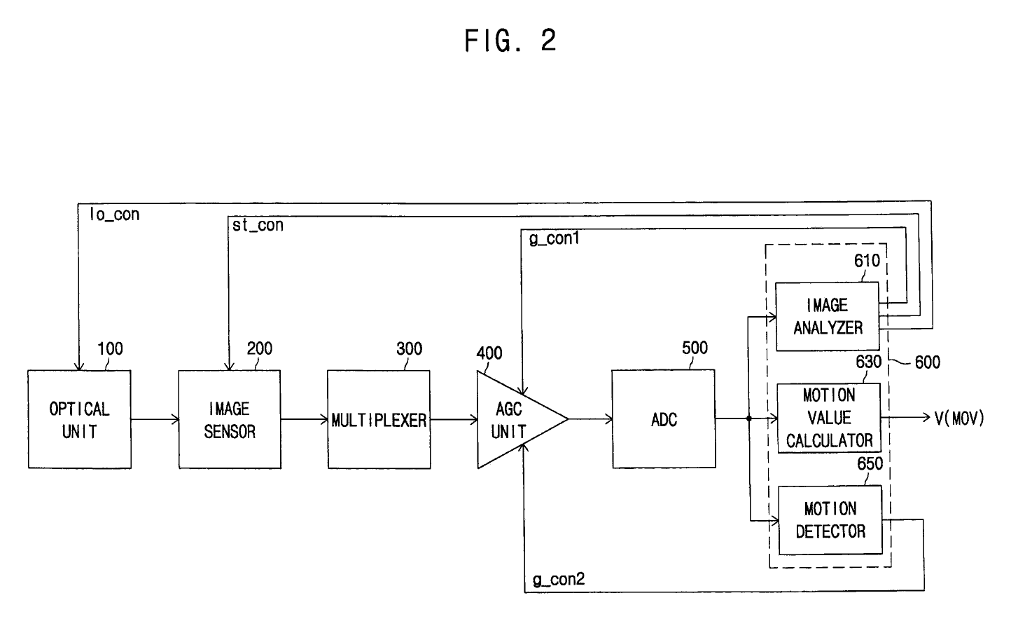

FIG. 2 is a block diagram of an optical pointing apparatus according to an exemplary embodiment of the present invention.

Referring to FIG. 2, the optical pointing apparatus includes an optical unit 100, an image sensor 200, a multiplexer 300, an automatic gain control (AGC) unit 400, an analog-to-digital converter (ADC) 500, and an image data processor 600. The image sensor 200 is comprised of a plurality of pixels, and the image data processor 600 includes an image analyzer 610, a motion value calculator 630, and a motion detector 650.

Functions of the blocks shown in FIG. 2 will now be described.

The optical unit 100 is comprised of a light source and a lens. The optical unit 100 radiates light onto a work surface using the light source in response to a light source control signal, and transmits light reflected by the work surface through the lens to the image sensor 200.

The image sensor 200 receives the reflected light through the lens and senses image data.

The multiplexer 300 selects one pixel or a small number of pixels out of a pixel array of the image sensor 200 and outputs an electrical signal having image data of the selected pixel.

The AGC unit 400 receives the electrical signal having the image data of the selected pixel from the multiplexer 300, controls the gain of the electrical signal in response to gain control signals g_con1 and g_con2 which depend on the work surface or the motion speed of the optical pointing apparatus, and outputs an analog gain output signal to the ADC 500.

The ADC 500 receives the analog gain output signal from the AGC unit 400 and converts the analog signal into a digital image signal. Up to now, the ADC 500 is described to be a simple conversion function only. But, it is natural that the AGC unit 400 is embedded into the ADC 500.

The image data processor 600 receives the digital image signal from the ADC 500. Then, the mage analyzer 610 analyzes brightness of the work surface and outputs a light source control signal lo_con, a shutter control signal st_con, and a first gain control signal g_con1. The motion detector 650 detects the motion speed of the optical pointing apparatus and outputs a second gain control signal g_con2. Thereafter, the motion value calculator 630 calculates a motion value V(MOV) based on the digital image signal output by the ADC 500, and outputs the motion value V(MOV).

Here, a method of generating the light source control signal lo_con, the shutter control signal st_con, and the first gain control signal g_con1 is known to one of ordinary skill in the art, and thus a detailed description thereof will be omitted.

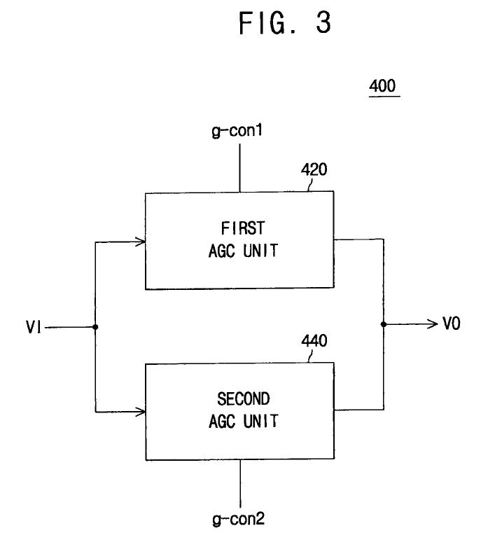

FIG. 3 is an internal block diagram of the AGC unit of the optical pointing apparatus shown in FIG. 2. Referring to FIG. 3, the AGC unit includes a first AGC unit 420 and a second AGC unit 440.

Functions of the blocks shown in FIG. 3 will now be described with reference to FIG. 3.

The first AGC unit 420 receives an electrical signal of a selected pixel from the multiplexer 300, controls the gain of the electrical signal in response to the first gain control signal g_con1 which depends on brightness and darkness from images of the work surface, and outputs a gain output

The second AGC unit 440 receives an electrical signal of a selected pixel from the multiplexer 300, controls the gain of the electrical signal in response to the second gain control signal g_con2 which depends on the motion speed of the optical pointing apparatus, and outputs a gain output signal.

Although the first and second AGC units 420 and 440 are illustrated as being connected in parallel in FIG. 3, the first and second AGC units 420 and 440 may be connected in series.

Specifically, when a shutter-on time is reduced by a predetermined time due to the bright color of the work surface, the gain of an electrical signal is compared with the maximum gain. And when the gain of the electrical signal is smaller than the maximum gain, the first AGC unit 420 maintains the gain of the electrical signal, while when the gain of the electrical signal is larger than the maximum gain, the first AGC unit 420 reduces the gain of the electrical signal by a predetermined level.

However, when a shutter-on time is increased by a predetermined time due to the dark color of the work surface, the gain of the electrical signal is compared with the minimum gain. And when the gain of the electrical signal is larger than the minimum gain, the first AGC unit 420 maintains the gain of the electrical signal, while when the gain of the electrical signal is smaller than the minimum gain, the first AGC unit 420 increases the gain of the electrical signal by a predetermined level.

Meanwhile, the second AGC unit 440 maintains the gain of the electrical signal when the average motion speed of the optical pointing apparatus is higher than the minimum speed and lower than the maximum speed, increases the gain of the electrical signal by a predetermined level when the average motion speed is higher than the maximum speed, and decreases the gain of the electrical signal by a predetermined level when the average motion speed is lower than the minimum speed.

Here, since the light source control signal lo_con, the shutter control signal st_con, and the first gain control signal g_con1 are output by the image analyzer 610 based on statistical characteristics of an image of the work surface, each of the light source control signal lo_con, the shutter control signal st_con, and the first gain control signal g_con1 is calculated irrespective of allowed maximum and minimum values. Examples of the statistical characteristics include the average, maximum and minimum values, standard deviation, and features of an image value of the work surface. The statistical characteristics are obtained without consideration of anomalies caused by defects of pixels or electrical defects.

Operation of the optical pointing apparatus according to the present embodiment will now be described with reference to FIGS. 2 and 3.

When the optical unit 100 radiates light onto the work surface using the light source, the image sensor 200 receives light reflected by the work surface through the lens, senses brightness and darkness from images of the work surface, and outputs image data.

The multiplexer 300 receives the sensed image data from the image sensor 200, selects a single pixel or a small number of pixels out of the plurality of pixels, and outputs an electrical signal having image data of the selected pixel.

The AGC unit 400 receives the electrical signal having the image data of the selected pixel from the multiplexer 300 and controls the gain of the electrical signal. When a predetermined shutter-on time elapses, the AGC unit 400 controls the gain of the electrical signal in response to the first and second gain control signals g_con1 and g_con2 and outputs an analog gain output signal to the ADC 500.

The ADC 500 receives the analog gain output signal output from the AGC unit 400 and converts the analog gain output signal into a digital image. The image analyzer 610 receives the digital image signal from the ADC 500, analyzes brightness and darkness from images of the work surface, outputs the light source control signal lo_con for controlling the illumination of the light source, the shutter control signal st_con for controlling the shutter-on time, and the gain control signal g_con1 for controlling the gain of the electrical signal, and feeds the light source control signal lo_con, the shutter control signal st_con, and the first gain control signal g_con1 back to the optical unit 100, the image sensor 200, and the AGC unit 400, respectively.

That is, when the work surface is bright, the ADC 500 outputs a shutter control signal st_con for reducing a shutter-on time, a light source control signal lo_con for reducing a light-on time, and a first gain control signal g_con1 for reducing the gain of the ADC input data. Conversely, when the work surface is dark, the ADC 500 outputs a shutter control signal st_con for increasing a shutter-on time, a light source control signal lo_con for increasing a light-on time, and a first gain control signal g_con1 for increasing the gain of the ADC input data.

Also, the motion detector 650 receives the digital image signal from the ADC 500, detects the motion speed of the optical pointing apparatus, outputs the second gain control signal g_con2 for controlling the gain of the ADC input data, and feeds the second gain control signal g_con2 back to the AGC unit 400.

That is, the motion detector 650 outputs a second gain control signal g_con2 for reducing the gain of the ADC input data when the motion speed of the optical pointing apparatus is lower than the minimum speed, and outputs a second gain control signal g_con2 for increasing the gain of the ADC input data when the motion speed of the optical pointing apparatus is higher than the maximum speed.

Meanwhile, the motion value calculator 630 receives the digital image signal converted by the ADC 500, calculates a correlation value between current image data and previous image data, calculates a coordinate motion value V(MOV) of the optical pointing apparatus based on the correlation value, and outputs the coordinate motion value V(MOV).

Control of the shutter-on time and control of the gain of the electrical signal are performed such that the average of an output signal of the ADC 500 is maintained constant. In order to minimize power consumption of the optical pointing apparatus, the AGC unit 400 must control the gain of the image signal at the same time to minimize the shutter-on time.

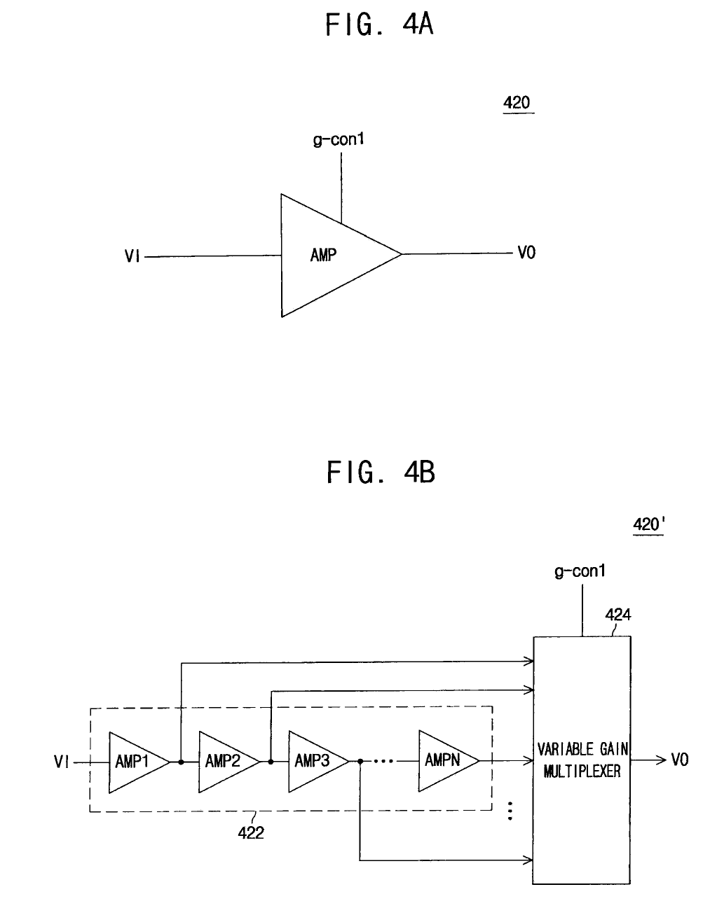

Each of the first and second AGC units 420 and 440 of the AGC unit 400 of the optical pointing apparatus shown in FIG. 3 may include a single variable gain amplifier AMP as shown in FIG. 4A, so that a gain output signal may be output in a linear gain range in an analog mode according to voltage levels of the gain control signals g_con1 and g_con2. Alternatively, each of the first and second AGC units 420 and 440 of the AGC unit 400 of the optical pointing apparatus shown in FIG. 3 may include a plurality of variable gain amplifiers AMP1 to AMPN as shown in FIG. 4B, so that an output signal may be selectively output in a discontinuous gain range according to voltage levels of the first and second gain control signals g_con1 and g_con2.

FIG. 4A is a circuit diagram of a first example of the first AGC unit of the AGC unit shown in FIG. 3. Referring to FIG. 4A, the first AGC unit 420 includes the single variable gain amplifier AMP.

Operation of the AGC unit 400 of the optical pointing apparatus will now be described with reference to FIG. 4A.

The variable gain amplifier AMP receives an electrical signal of a selected pixel from the multiplexer 300, controls the gain of the electrical signal by a predetermined level, and outputs a gain output signal. In this case, the variable gain amplifier AMP continuously outputs the gain output signal in an analog mode in response to voltage levels of the gain control signals g_con1 and g_con2 which depend on brightness and darkness from images of the work surface or the motion speed of the optical pointing apparatus.

FIG. 4B is a circuit diagram of a second example of the first AGC unit of the AGC unit shown in FIG. 3. Referring to FIG. 4B, the first AGC unit 420 includes a plurality of variable gain amplifiers 422 and a variable gain multiplexer 424.

Operation of the AGC unit of the optical pointing apparatus will now be described with reference to FIG. 4B.

The plurality of variable gain amplifiers AMP1 to AMPN are connected in series. Thus, a first variable gain amplifier AMP1 receives an electrical signal of a selected pixel from the multiplexer 300, controls the gain of the electrical signal by a predetermined level, and outputs a first gain output signal. Also, a second variable gain amplifier AMP2 receives the first gain output signal from the first variable gain amplifier AMP1, controls the gain of the first gain output signal by a predetermined level, and outputs a second gain output signal.

Similarly, each of third through N-th variable gain amplifiers AMP3 to AMPN receives a gain output signal from a front-stage variable gain amplifier, controls the gain of the received gain output signal, and outputs the corresponding one of third to N-th gain output signals.

The variable gain multiplexer 424 receives the first through N-th gain output signals and selectively outputs one of the first through N-th gain output signals according to voltage levels of the gain control signals g_con1 and g_con2 which depend on brightness and darkness from images of the work surface or the motion speed of the optical pointing apparatus.

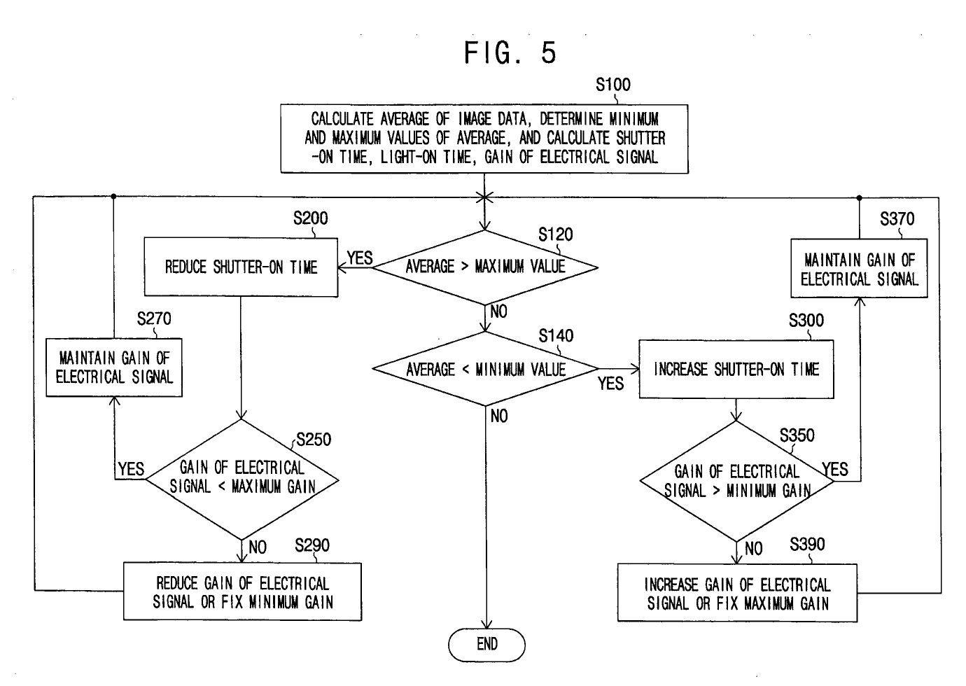

FIG. 5 is an operation flowchart of an optical pointing apparatus according to a first exemplary embodiment of the present invention, in a case where a shutter-on time is controlled prior to gain of an image signal according to the brightness of a work surface.

A method of controlling the gain of an ADC input signal of the optical pointing apparatus according to the embodiment of the present invention will now be described with reference to FIGS. 2, 3, and 5.

When the light source radiates light onto the work surface, the image sensor 200 senses brightness and darkness from images of the work surface, and outputs image data. The multiplexer 300 selects a single pixel or a small number of pixels and outputs an electrical signal having image data of the selected pixel. The AGC unit 400 receives the electrical signal having the image data of the selected pixel, controls the gain of the electrical signal, and outputs an analog gain output signal to the ADC 500. The ADC 500 receives the analog gain output signal from the AGC unit 400 and converts the analog signal into a digital image signal. The motion detector 650 detects the motion speed of the optical pointing apparatus, outputs the second gain control signal g_con2, and feeds the second gain control signal g_con2 back to the AGC unit 400. The motion calculator 630 receives the digital image signal from the ADC 500 and calculates and outputs a coordinate motion value V(MOV) of the optical pointing apparatus. Since the foregoing operation of the optical pointing apparatus shown in FIG. 2 was described in detail above, a further detailed description thereof will not be described again here.

The image analyzer 610 receives the digital image signal from the ADC 500 and analyzes brightness and darkness from images of the work surface. Referring to FIG. 5, in step S100, the average of the digital image signal output by the ADC 500 is calculated, the minimum and maximum values of the average are determined, and a shutter-on time, a light-on time, and the gain of an electrical signal are calculated. In steps S120 and 140, the average of the digital image signal is compared with the maximum and minimum values.

When the work surface is bright, the average of the digital image signal output by the ADC 500 is higher than the maximum value. In this case, the shutter-on time is reduced by a predetermined time in step S200.

Thereafter, the gain of the electrical signal to be input to the ADC 500 is compared with the maximum gain in step S250, while when the gain of the electrical signal is smaller than the maximum gain, the gain of the electrical signal is maintained in step S270. When the gain of the electrical signal is larger than the maximum gain, the gain of the electrical signal is reduced by a predetermined level or the minimum gain is fixed in step S290.

Meanwhile, when the work surface is dark, the average of the digital image signal output by the ADC 500 is lower than the maximum value. In this case, the shutter-on time is increased by a predetermined time in step S300.

Thereafter, the gain of the electrical signal to be input to the ADC 500 is compared with the minimum gain in step S350. When the gain of the electrical signal is larger than the minimum gain, the gain of the electrical signal is maintained in step S370, while when the gain of the electrical signal is smaller than the minimum gain, the gain of the electrical signal is increased by a predetermined level or the maximum gain is in step S390.

After all the steps are finished, the process returns to steps S120 and S140 in which the average of the digital image signal is compared with the maximum and minimum values.

While it is described above that the gain of the electrical signal is reduced and increased in steps S290 and S390, alternatively, the gain of the electrical signal may be fixed. In particular, when the gain of the electrical signal reaches the minimum gain and cannot be reduced any more, or the maximum gain and cannot be not increased any more, the gain of the electrical signal may be fixed at the minimum or maximum gain.

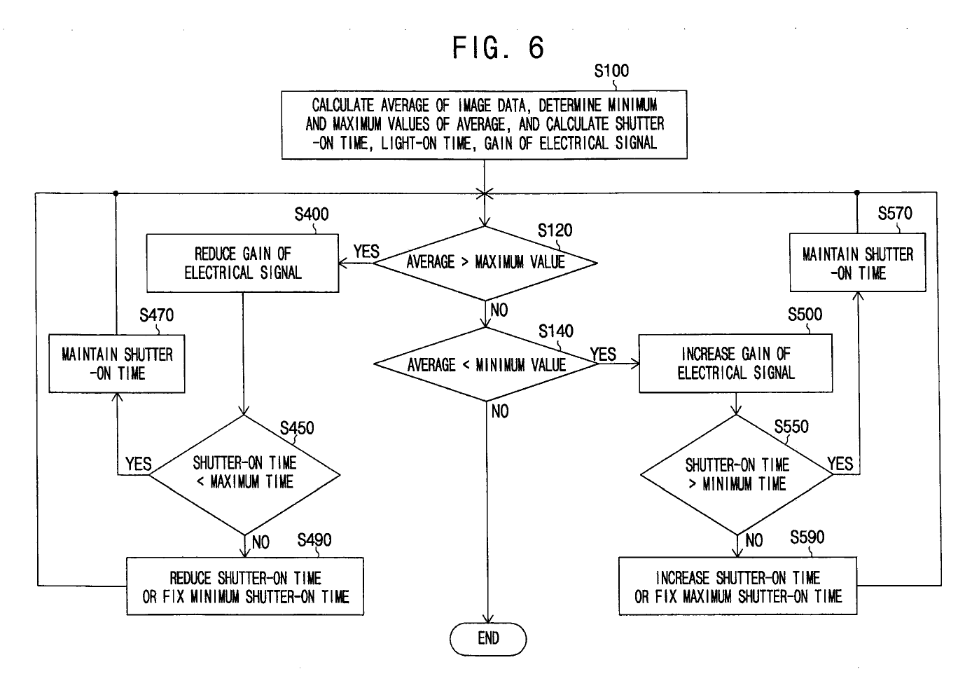

FIG. 6 is an operation flowchart of an optical pointing apparatus according to a second exemplary embodiment of the present invention, in a case where gain of an image signal is controlled prior to a shutter-on time according to the brightness of a work surface.

A method of controlling the gain of an ADC input signal of the optical pointing apparatus according to the embodiment of the present invention will now be described with reference to FIGS. 2, 3, and 6.

Again, since operation of the image sensor 200, the multiplexer 300, the AGC unit 400, the ADC 500, the motion detector 650, and the motion value calculator 630 of the optical pointing apparatus shown in FIG. 2 was described in detail above, such description will not be repeated here.

The image analyzer 610 receives the digital image signal from the ADC 500 and analyzes brightness and darkness from images of the work surface. Referring to FIG. 6, in step S100, the average of the digital image signal output by the ADC 500 is calculated, the minimum and maximum values of the average are determined, and a shutter-on time, a light-on time, and the gain of an electrical signal are calculated. In steps S120 and 140, the average of the digital image signal is compared with the maximum and minimum values.

When the work surface is bright, the average of the digital image signal output by the ADC 500 is higher than the maximum value. In this case, the gain of the electrical signal to be input to the ADC 500 is reduced by a predetermined level in step S400.

Thereafter, the shutter-on time is compared with the maximum time in step S450. Thus, when the shutter-on time is shorter than the maximum time, the shutter-on time is maintained in step S470. When the shutter-on time is longer than the maximum time, the shutter-on time is reduced by a predetermined time or the minimum shutter-on time is fixed in step S490.

Meanwhile, when the work surface is dark, the average of the digital image signal output by the ADC 500 is lower than the maximum value. In this case, the gain of the electrical signal to be input to the ADC 500 is increased by a predetermined level in step S500.

Thereafter, the shutter-on time is compared with the minimum time in step S550 Thus, when the shutter-on time is longer than the minimum time, the shutter-on time is maintained in step S570, and when the shutter-on time is shorter than the minimum time, the shutter-on time is increased by a predetermined time or the maximum shutter-on time is fixed in step S590

After all the steps are finished, the process returns to steps S120 and S140 in which the average of the digital image signal is compared with the maximum and minimum values.

While it is described above that the shutter-on time is reduced and increased in steps S490 and S590, alternatively, the gain of the electrical signal may be fixed. In particular, when the shutter-on time reaches the minimum time and cannot be reduced any more, or the maximum time and cannot be increased any more, the shutter-on time may be fixed at the minimum or maximum time.

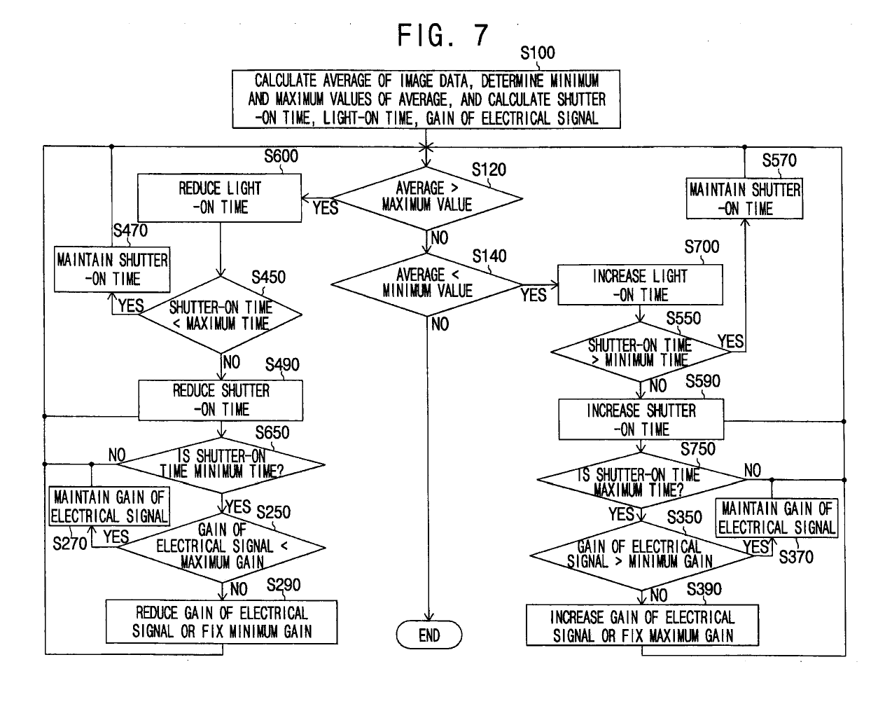

FIG. 7 is an operation flowchart of an optical pointing apparatus according to a third exemplary embodiment of the present invention, in a case where a light-on time is controlled prior to gain of an image signal and a shutter-on time according to the brightness of a work surface.

A method of controlling the gain of an ADC input signal of the optical pointing apparatus according to the embodiment of the present invention will now be described with reference to FIGS. 2, 3, and 7.

Again, since operation of the image sensor 200, the multiplexer 300, the AGC unit 400, the ADC 500, the motion detector 650, and the motion value calculator 630 of the optical pointing apparatus shown in FIG. 2 was described in detail above, a description thereof will not be repeated here.

The image analyzer 610 receives the digital image signal from the ADC 500 and analyzes brightness and darkness from images of the work surface. Referring to FIG. 7, in step S100, the average of the digital image signal output by the ADC 500 is calculated, the minimum and maximum values of the average are determined, and a shutter-on time, a light-on time, and the gain of an electrical signal are calculated. In steps S120 and 140, the average of the digital image signal is compared with the maximum and minimum values.

When the work surface is bright, the average of the digital image signal output by the ADC 500 is higher than the maximum value. In this case, the light-on time is reduced by a predetermined time in step S600.

Thereafter, the shutter-on time is compared with the maximum time in step S450. When the shutter-on time is shorter than the maximum time, the shutter-on time is maintained in step S470. When the shutter-on time is longer than the maximum time, the shutter-on time is reduced by a predetermined time in step S490.

It is determined whether the reduced shutter-on time is the minimum time in step S650. When the reduced shutter-on time is not the minimum time, the process returns to steps S120 and S140 in which the average of the digital image signal is compared with the maximum and minimum values. When the reduced shutter-on time is equal to or smaller than the minimum time, the gain of the electrical signal to be input to the ADC 500 is compared with the maximum gain in step S250. And when the gain of the electrical signal is smaller than the maximum gain, the gain of the electrical signal is maintained in step S270, while when the gain of the electrical signal is larger than the maximum gain, the gain of the electrical signal is reduced by a predetermined level in step S290.

Meanwhile, when the work surface is dark, the average of the digital image signal output by the ADC 500 is lower than the maximum value. In this case, the light-on time is increased by a predetermined time in step S700.

Thereafter, the shutter-on time is compared with the minimum time in step S550. When the shutter-on time is longer than the minimum time, the shutter-on time is maintained in step S570, and when the shutter-on time is shorter than the minimum time, the shutter-on time is increased by a predetermined time in step S590.

It is determined if the increased shutter-on time is the maximum time in step S750. When the reduced shutter-on time is not the maximum time, the process returns to steps S120 and S140. When the increased shutter-on time is the maximum time, the gain of the electrical signal to be input to the ADC 500 is compared with the minimum gain in step S350. Thus, when the gain of the electrical signal is larger than the minimum gain, the gain of the electrical signal is maintained in step S370. When the gain of the electrical signal the gain of the electrical signal is smaller than the minimum gain, the gain of the electrical signal is increased by a predetermined level in step S390.

After all the steps are finished, the process returns to steps S120 and S140.

Like in FIG. 5, it is described above that the gain of the electrical signal is reduced and increased in steps S290 and S390, respectively, for brevity, but the gain of the electrical signal may be fixed. In particular, when the gain of the electrical signal reaches the minimum gain and cannot be reduced any more, or the maximum gain and cannot be increased any more, the gain of the electrical signal may be fixed at the minimum or maximum gain.

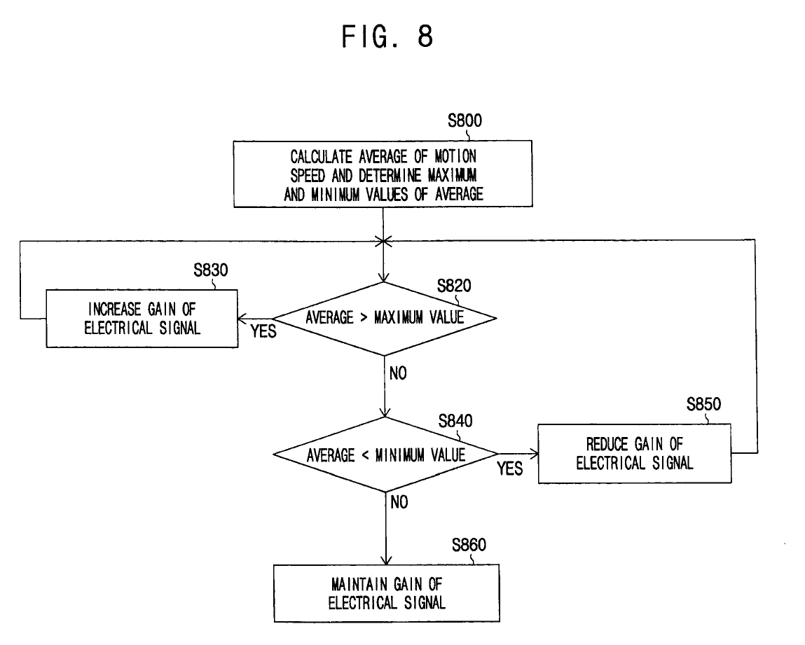

FIG. 8 is an operation flowchart of an optical pointing apparatus according to a fourth another exemplary embodiment of the present invention, in a case where gain of an image signal is controlled according to motion speed.

A method of controlling the gain of an ADC input signal of the optical pointing apparatus according to the embodiment of the present invention will now be described with reference to FIGS. 2, 3, and 8.

Again, since operation of the image sensor 200, the multiplexer 300, the AGC unit 400, the ADC 500, the motion detector 650, and the motion value calculator 630 of the optical pointing apparatus shown in FIG. 2 was described in detail above, a description thereof will not be repeated here.

The motion detector 650 receives a digital image signal from the ADC 500 and detects the motion speed of the optical pointing apparatus. Referring to FIG. 8, in step S800, the average motion speed of the optical pointing apparatus is calculated and the maximum and minimum values of the average are determined. In steps S820 and 840, the average motion speed of the optical pointing apparatus is compared with the maximum and minimum speeds.

When the optical pointing apparatus moves at high speed, the average motion speed of the optical pointing apparatus may be higher than the maximum speed. In this case, the gain of the electrical signal to be input to the ADC 500 is increased by a predetermined level in step S830.

When the optical pointing apparatus moves at low speed, the average motion speed of the optical pointing apparatus may be lower than the minimum speed. In this case, the gain of the electrical signal to be input to the ADC 500 is reduced by a predetermined level in step S850.

When the optical pointing apparatus moves at an appropriate speed, the average motion speed of the optical pointing apparatus may be lower than the maximum speed and higher than the minimum speed. In this case, the gain of the electrical signal to be input to the ADC 500 is maintained in step S860.

After all the steps are finished, the process returns to steps S820 and S840.

As described above, when the work surface is dark and the optical pointing apparatus moves fast, the gain of the electrical signal to be input to the ADC 500 is increased. Otherwise, that is, when the work surface is bright or the optical pointing apparatus moves slowly, the gain of the electrical signal to be input to the ADC 500 is adaptively controlled according to brightness and darkness from images of the work surface or the motion speed of the optical pointing apparatus to be in a normal state.

According to the present invention, power consumption of the optical pointing apparatus can be minimized. Also, even if the optical pointing apparatus is placed on a dark work surface or moves at high speed, a required light intensity can be fluidly ensured, and a precise image can be obtained in response to an input signal having at least a predetermined light intensity.

Exemplary embodiments of the present invention have been disclosed herein and, although specific terms are employed, they are used and are to be interpreted in a generic and descriptive sense only and not for purposes of limitation. Accordingly, it will be understood by those of ordinary skill in the art that various changes in form and details may be made without departing from the spirit and scope of the present invention as set forth in the following claims.

1. An optical pointing apparatus comprising:
an image sensor comprised of a plurality of pixels, for receiving light reflected by a work surface, sensing image data, and outputting an electrical signal;
an automatic gain control (AGC) unit for receiving the electrical signal, controlling the gain of the electrical signal according to brightness and darkness from images of the work surface and the motion speed of the optical pointing apparatus, and outputting a gain output signal; and
an image data processor for receiving the gain output signal, analyzing brightness and darkness from images of the work surface to control the gain of the electrical signal, detecting the motion speed of the optical pointing apparatus to control the gain of the electrical signal, and calculating and outputting the motion speed of the optical pointing apparatus.

2. The apparatus according to claim 1, further comprising:
an optical unit for radiating light onto the work surface using a light source and transmitting the light reflected by the work surface through a lens;
a multiplexer for receiving the electrical signal, selecting at least one pixel out of the plurality of pixels, and outputting an electrical signal of the selected pixel; and
an analog-to-digital converter (ADC) for receiving the gain output signal and converting the gain output signal into a digital image signal.

3. The apparatus according to claim 1, wherein the AGC unit receives the electrical signal of the selected pixel, compares the gain of the electrical signal with a maximum gain and a minimum gain, maintains the gain of the electrical signal when the gain of the electrical signal is smaller than the maximum gain or larger than the minimum gain, reduces the gain of the electrical signal by a predetermined level when the gain of the electrical signal is larger than the maximum gain, and increases the gain of the electrical signal by a predetermined level when the gain of the electrical signal is smaller than the minimum gain.

4. The apparatus according to claim 3, wherein the AGC unit includes a single variable gain amplifier, which outputs the gain output signal in a linear gain range in an analog mode according to voltage levels of gain control signals.

5. The apparatus according to claim 3, wherein the AGC unit includes a plurality of variable gain amplifiers, which selectively output the gain output signal in a discontinuous gain range according to voltage levels of gain control signals.

6. The apparatus according to claim 5, wherein the AGC unit comprises:
a first variable gain amplifier for receiving the electrical signal of the selected pixel, controlling the gain of the electrical signal by a predetermined level, and outputting a first gain output signal;
second through N-th variable gain amplifiers connected to the first variable gain amplifier in series for receiving a gain output signal from a front-stage variable gain amplifier, controlling the gain of the received gain output signal by a predetermined level, and outputting a corresponding one of second through N-th gain output signals; and
a variable gain multiplexer for receiving the first through N-th gain output signals and selectively outputting one of the first through N-th gain output signals according to brightness and darkness from images of the work surface or the motion speed of the optical pointing apparatus, in response to the voltage levels of the gain control signals.

7. The apparatus according to claim 1, wherein the image data processor comprises:
an image analyzer for receiving the digital image signal, analyzing brightness and darkness from images of the work surface, outputting a light source control signal for controlling the illumination of the light source to the optical unit, outputting a shutter control signal for controlling a shutter-on time to the image sensor, and outputting a first gain control signal for controlling the gain of the electrical signal of the selected pixel to the AGC unit;
a motion detector for receiving the digital image signal, detecting the motion speed of the optical pointing apparatus, and outputting a second gain control signal to the AGC unit; and
a motion value calculator for receiving the digital image signal, calculating a correlation value between current image data and previous image data, calculating a coordinate motion value of the optical pointing apparatus based on the correlation value, and outputting the coordinate motion value.

8. The apparatus according to claim 7, wherein the image analyzer outputs a shutter control signal for reducing the shutter-on time, a light source control signal for reducing a light-on time, and a gain control signal for reducing the gain of the electrical signal of the selected pixel when the work surface is bright, and outputs a shutter control signal for increasing the shutter-on time, a light source control signal for increasing the light-on time, and a gain control signal for increasing the gain of the electrical signal of the selected pixel.

9. The apparatus according to claim 7, wherein the image analyzer receives the digital image signal, calculates the average of the digital image signal, compares the average with minimum and maximum values, and outputs the shutter control signal prior to the gain control signal,
wherein the image analyzer outputs a shutter control signal for reducing the shutter-on time by a predetermined time when the average is larger than the maximum value, and outputs a shutter control signal for increasing the shutter-on time by a predetermined time when the average is smaller than the minimum value.

10. The apparatus according to claim 7, wherein the image analyzer receives the digital image signal, calculates the average of the digital image signal, compares the average with minimum and maximum values, outputs a gain control signal for reducing the gain of the electrical signal of the selected pixel by a predetermined level when the average is larger than the maximum value, and outputs the gain control signal prior to the shutter control signal,
wherein the image analyzer outputs a gain control signal for increasing the gain of the electrical signal of the selected pixel by a predetermined level when the average is smaller than the minimum value.

11. The apparatus according to claim 7, wherein the image analyzer receives the digital image signal, calculates the average of the digital image signal, compares the average with minimum and maximum values, and outputs the light source control signal prior to the shutter control signal and the gain control signal,
wherein the image analyzer outputs a light source control signal for reducing the light-on time by a predetermined time when the average is larger than the maximum value, and outputs a light source control signal for increasing the light-on time by a predetermined time when the average is smaller than the minimum value.

12. The apparatus according to claim 7, wherein the motion detector outputs a gain control signal for reducing the gain of the electrical signal of the selected pixel when the motion speed of the optical pointing apparatus is lower than a minimum speed, and outputs a gain control signal for increasing the gain of the electrical signal of the selected pixel when the motion speed of the optical pointing apparatus is higher than a maximum speed.

13. An automatic gain control (AGC) method of an optical pointing apparatus comprising an image sensor for receiving light reflected by a work surface, sensing image data, and outputting an electrical signal, and an analog-to-digital converter (ADC) for converting the electrical signal into a digital image signal, the method comprising:
an AGC step including receiving the electrical signal, controlling the gain of the electrical signal according to brightness and darkness from images of the work surface and the motion speed of the optical pointing apparatus, and outputting a gain output signal; and
an image data processing step including receiving the gain output signal, analyzing brightness and darkness from images of the work surface to control the gain of the electrical signal, detecting the motion speed of the optical pointing apparatus to control the gain of the electrical signal, and calculating and outputting a motion value of the optical pointing apparatus.

14. The method according to claim 13, wherein the AGC step comprises comparing the gain of the electrical signal with maximum and minimum gains, maintaining the gain of the electrical signal when the gain of the electrical signal is larger than a maximum gain or smaller than a minimum gain, reducing the gain of the electrical signal by a predetermined level when the gain of the electrical signal is larger than the maximum gain, and increasing the gain of the electrical signal by a predetermined level when the gain of the electrical signal is smaller than the minimum gain.

15. The method according to claim 13, wherein the image data processing step comprises:
an image analysis step including receiving the digital image signal, analyzing brightness and darkness from images of the work surface, and outputting a light source control signal for controlling the illumination of a light source, a shutter control signal for controlling a shutter-on time, and a first gain control signal for controlling the gain of the electrical signal;
a motion detection step including receiving the digital image signal, detecting the motion speed of the optical pointing apparatus, and outputting a second gain control signal; and
a motion value calculation step including receiving the digital image signal, calculating a correlation value between current image data and previous image data, calculating a coordinate motion value of the optical pointing apparatus based on the correlation value, and outputting the coordinate motion value.

16. The method according to claim 15, wherein the image analysis step comprises:
outputting a shutter control signal for reducing the shutter-on time, a light source control signal for reducing a light-on time, and a gain control signal for reducing the gain of the electrical signal when the work surface is bright; and
outputting a shutter control signal for increasing the shutter-on time, a light source control signal for increasing a light-on time, and a gain control signal for increasing the gain of the electrical signal when the work surface is dark.

17. The method according to claim 16, wherein the image analysis step comprises:
a work surface brightness analysis step including receiving the digital image signal, calculating the average of the digital image signal, and comparing the average with minimum and maximum values;
a shutter-on time control step including reducing the shutter-on time by a predetermined time when the average is larger than the maximum value and increasing the shutter-on time by a predetermined time when the average is smaller than the minimum value;
a first gain control step including comparing the gain of the electrical signal with the maximum gain to control the gain of the electrical signal when the shutter-on time is reduced by the predetermined time; and
a second gain control step including comparing the gain of the electrical signal with the minimum gain to control the gain of the electrical signal when the shutter-on time is increased by the predetermined time.

18. The method according to claim 17, wherein the first gain control step comprises:
comparing the gain of the electrical signal with the maximum gain;
maintaining the gain of the electrical signal when the gain of the electrical signal is smaller than the maximum gain; and
reducing the gain of the electrical signal by a predetermined level when the gain of the electrical signal is larger than the maximum gain.

19. The method according to claim 17, wherein the second gain control step comprises:
comparing the gain of the electrical signal with the minimum gain;
maintaining the gain of the electrical signal when the gain of the electrical signal is larger than the minimum gain; and
increasing the gain of the electrical signal by a predetermined level than when the gain of the electrical signal is smaller than the minimum gain.

20. The method according to claim 17, wherein the image analysis step further comprises returning to the work surface brightness analysis step after performing the first and second gain control steps.

21. The method according to claim 16, wherein the image analysis step comprises:
a work surface brightness analysis step including receiving the digital image signal, calculating the average of the digital image signal, and comparing the average with minimum and maximum values;
a gain control step including reducing the gain of the electrical signal by a predetermined level when the average is larger than the maximum value and increasing the gain of the electrical signal by a predetermined level when the average is smaller than the minimum value;
a first shutter-on time control step including comparing the shutter-on time with a maximum shutter-on time to control the shutter-on time when the gain of the electrical signal is reduced by the predetermined level; and
a second shutter-on time control step including comparing the shutter-on time with a minimum shutter-on time to control the shutter-on time when the gain of the electrical signal is increased by the predetermined level.

22. The method according to claim 21, wherein the image analysis step further comprises returning to the work surface brightness analysis step after performing the first and second shutter-on time control steps.

23. The method according to claim 16, wherein the image analysis step comprises:
a work surface brightness analysis step including receiving the digital image signal, calculating the average of the digital image signal, and comparing the average with minimum and maximum values;
a light-on time control step including reducing the light-on time by a predetermined time when the average is larger than the maximum value and increasing the light-on time by a predetermined time when the average is smaller than the minimum value;
a first shutter-on time control step including comparing the shutter-on time with a maximum shutter-on time to control the shutter-on time when the light-on time is reduced by the predetermined time; and
a second shutter-on time control step including comparing the shutter-on time with a minimum shutter-on time to control the shutter-on time when the light-on time is increased by the predetermined time.

24. The method according to claim 23, wherein the first shutter-on time control step comprises:
comparing the shutter-on time with the maximum shutter-on time;
maintaining the shutter-on time when the shutter-on time is shorter than the maximum shutter-on time; and
reducing the shutter-on time by the predetermined time when the shutter-on time is longer than the maximum shutter-on time.

25. The method according to claim 23, wherein the second shutter-on time control step comprises:
comparing the shutter-on time with the minimum shutter-on time;
maintaining the shutter-on time when the shutter-on time is longer than the minimum shutter-on time; and
increasing the shutter-on time by the predetermined time when the shutter-on time is shorter than the minimum shutter-on time.

26. The method according to claim 23, wherein the image analysis step comprises:
a first determination of shutter-on time step including determining if the shutter-on time reduced in the first shutter-on time control step is the minimum shutter-on time;
a first gain control step including returning to the work surface brightness analysis step when the reduced shutter-on time is not the minimum shutter-on time, and comparing the gain of the electrical signal with the maximum gain to control the gain of the electrical signal when the reduced shutter-on time is the minimum shutter-on time;
a second determination of shutter-on time step including determining if the shutter-on time increased in the second shutter-on time control step is the maximum shutter-on time; and
a second gain control step including returning to the work surface brightness analysis step when the increased shutter-on time is not the maximum shutter-on time, and comparing the gain of the electrical signal with the minimum gain to control the gain of the electrical signal when the increased shutter-on time is the maximum shutter-on time.

27. The method according to claim 26, wherein the first gain control step comprises:
comparing the gain of the electrical signal with the maximum gain;
maintaining the gain of the electrical signal when the gain of the electrical signal is smaller than the maximum gain; and
reducing the gain of the electrical signal by a predetermined level when the gain of the electrical signal is larger than the maximum gain.

28. The method according to claim 26, wherein the second gain control step comprises:
comparing the gain of the electrical signal with the minimum gain;
maintaining the gain of the electrical signal when the gain of the electrical signal is larger than the minimum gain; and
increasing the gain of the electrical signal by a predetermined level when the gain of the electrical signal is smaller than the minimum gain.

29. The method according to claim 26, wherein the image analysis step further comprises returning to the work surface brightness analysis step after performing the first and second gain control steps.

30. The method according to claim 15, wherein the motion detection step comprises:
a motion speed analysis step including receiving the digital image signal, calculating the average motion speed of the optical pointing apparatus, and comparing the average motion speed with maximum and minimum speeds;
maintaining the gain of the electrical signal when the average motion speed is higher than the minimum speed and lower than the maximum speed;
increasing the gain of the electrical signal by a predetermined level when the average motion speed is higher than the maximum speed; and
reducing the gain of the electrical signal by a predetermined level when the average motion speed is lower than the minimum speed.

31. The method according to claim 30, wherein the motion detection step further comprises returning to analyzing the motion speed of the optical pointing apparatus after controlling the gain of the electrical signal.

32. The method according to claim 21, wherein the first shutter-on time control step comprises:
comparing the shutter-on time with the maximum shutter-on time;
maintaining the shutter-on time when the shutter-on time is shorter than the maximum shutter-on time; and
reducing the shutter-on time by the predetermined time when the shutter-on time is longer than the maximum shutter-on time.

33. The method according to claim 21, wherein the second shutter-on time control step comprises:
comparing the shutter-on time with the minimum shutter-on time;
maintaining the shutter-on time when the shutter-on time is longer than the minimum shutter-on time; and
increasing the shutter-on time by the predetermined time when the shutter-on time is shorter than the minimum shutter-on time.

34. The method according to claim 22, wherein the image analysis step comprises:
a first determination of shutter-on time step including determining if the shutter-on time reduced in the first shutter-on time control step is the minimum shutter-on time;
a first gain control step including returning to the work surface brightness analysis step when the reduced shutter-on time is not the minimum shutter-on time, and comparing the gain of the electrical signal with the maximum gain to control the gain of the electrical signal when the reduced shutter-on time is the minimum shutter-on time;
a second determination of shutter-on time step including determining if the shutter-on time increased in the second shutter-on time control step is the maximum shutter-on time; and
a second gain control step including returning to the work surface brightness analysis step when the increased shutter-on time is not the maximum shutter-on time, and comparing the gain of the electrical signal with the minimum gain to control the gain of the electrical signal when the increased shutter-on time is the maximum shutter-on time.
